(19) United States
(12) Patent Application Publication
(10) Pub. No.: US 2015/0114485 A1
(43) Pub. Date: Apr. 30, 2015

(54) INSTALLATION SYSTEM FOR VALVES

(71) Applicant: St. Jude Children's Research Hospital, Memphis, TN (US)

(72) Inventors: Victor Amador, Memphis, TN (US); David Sobczak, Bartlett, TN (US)

(73) Assignee: St. Jude Children's Research Hospital, Memphis, TN (US)

(21) Appl. No.: 14/061,917

(22) Filed: Oct. 24, 2013

(51) Int. Cl. B23P 19/04

(52) U.S. Cl. CPC B23P 19/04
USPC 137/328

(57) ABSTRACT

A valve installation system including a bracket and a wrench. The bracket has a bottom section from which left and right side sections extend perpendicularly. The left and right sections terminate with prongs defining a recess therebetween for receiving and supporting an arm of a valve when the valve is engaged with the bracket. The wrench includes a generally rectangular body with a cutout proximate an end of the body. The cutout is preferably angled into the body and away from the proximate end.

### CROSS-REFERENCE TO RELATED APPLICATIONS

None.

### BACKGROUND OF THE INVENTION

A cyclotron is a particle accelerator in which charged particles accelerate outward from a center along a spiral path. The particles are generally held to a spiral trajectory by a static magnetic field and are accelerated by a rapidly varying electric field. Cyclotrons were originally developed for use in particle physics research. More recently, they have been used in the medical field by research hospitals. Cyclotrons can be used in particle therapy to treat cancer by generating ion beams—as in proton therapy—to penetrate the body and kill tumors by radiation damage while minimizing damage to healthy tissue along their path. Cyclotron beams can also be used to bombard other atoms to produce short-lived positron-emitting isotopes suitable for PET imaging. More recently cyclotrons currently installed at hospitals for particle therapy have been retrofitted to enable them to produce technetium-99, which is a diagnostic isotope.

Some cyclotrons utilize various valves during their operation, such as, for a non-limiting example, a CYCLONE® 18/9 cyclotron manufactured by IBA Group. One non-limiting example of such a valve is manufactured by Parker Hannifin Corporation with part number 009-0272-900, and is shown in FIG. 1. This valve is a two-way valve, and many of these valves are typically installed in close proximity to one another for use on a cyclotron. As can be seen, the example valve in FIG. 1 has a generally cylindrical upper portion, and a generally cubic lower portion with opposing arms extending to connection ports from the left and right side of the lower cubic portion. The ports connect the valve to a liquid or gas stream, and preferably a gas stream pressurized at up to 60-bar/870-PSI. At least a portion of each arm is therefore generally squared-off rather than rounded, so as to allow a wrench to easily grasp the arm. The bottom of the lower cubic portion has two threaded mounting holes.

Installing a fitting on such a valve without damaging the ports can be somewhat difficult. Typically, a standard wrench is used to secure a port via the corresponding arm while the connection to the delivery line is being tightened. However, applying too much pressure can cause the port to bend and cause a pin-hole crack at the brazed connection between the arm and the valve body. Such pin-hole cracks may result in radioactive gases leaking from the valve. As there are no valve body replacement parts available, the safest choice is to replace the entire valve when a bending of the port occurs. However, it generally takes around thirty minutes to replace such a valve on a cyclotron, not including the time it takes for the background radiation level to lower sufficiently for safe entry into the vault or the time required for leak testing. The result is extensive cyclotron downtime and potentially radioactive exposure to the employee carrying out the repair. Further, there is a relatively high cost for replacing a large number of these valves over a period of time.

Additionally, the valve ports are often incompatible with commonly used fittings, due to differences in arm/shoulder heights. Such incompatibilities generally necessitate swaging the new tubing at the valve, which requires the use of one hand to press the tube against the valve port to keep the hardware in place. Thus, when new tubing is needed, the worker must (a) hold the valve, (b) hold the tubing against the valve port, and (3) tighten the compression fitting, all at the same time. This procedure is fairly difficult for a single worker.

A new system for installing such valves is needed which puts less strain on the ports to cause fewer bending incidents, and which frees a worker's hands to more efficiently carry out the repair.

### SUMMARY OF THE INVENTION

The present invention relates to embodiments of an installation system for a valve. Particularly, several embodiments of the invention relate to an installation system for a valve, including a supporting bracket and a wrench to help reduce bending of the valve ports during installation. The bracket includes a generally planar bottom section with a top surface and a bottom surface. Opposing side sections each extend perpendicularly from opposing sides of the bottom section, creating an approximately 90 degree angle with the top surface of the planar bottom section. Each side section extends from a proximal end affixed to the bottom section, to a distal end. The distal end of each side section terminates with two prongs, which define a recess therebetween. The bottom section may include one or more through-holes which align with the threaded mounting holes on the valve upon mounting the bracket to a valve. However, in an alternative embodiment, the bracket may lack the through-holes in the bottom section, and may instead attach to the valve by any another known method, such as by resiliently deforming and rebounding to snap onto the valve.

In operation, the valve slides between the side sections until the bottom of the lower cubic portion of the valve and the top surface of the planar bottom section of the bracket abut one another. In one embodiment, the through-holes of the bracket align with the threaded mounting holes in the valve, as discussed above. The recess in each side section allows the respective arm of the valve to slide between the prongs on the side section as the valve slides into the bracket. Therefore, when engaged with a valve, the opposing arms of the valve extend through the recess in the side sections of the bracket. The prongs thereby act to brace the arms of the valve, and help prevent bending. The bracket thereby frees the worker from needed to hold the valve, freeing one hand to hold the tubing against the valve port while the other hand tightens the compression fitting.

Additionally, in one embodiment, the invention includes an improved wrench used to secure the arms while the connection to the delivery line is being tightened once the tubing has already been swaged. The wrench preferably includes a body which is elongated and generally rectangular in shape. Thus, the body generally has a length much longer than its width, and a depth which is smaller than the length or width. Any or all of the four corners may be rounded off or chamfered. Along the length of the body, proximate either or both ends thereof, the body preferably includes a cutout sized and shaped to receive an arm of a valve therein. The cutout is preferably angled at about 45 degrees into the body and away from the proximate end. The cutout preferably extends all the way through the depth of the body, but not all the way through its width.

In operation, the positioning and orientation of the cutout and the shape of the body allow the wrench to engage with the arm of a valve even when the valve is fitted among other nearby valves. Further, the user is less likely to cause the arm of the valve to bend due to the orientation of the cutout in the body of the wrench. The wrench may feature two cutouts at opposing ends and sides of the wrench to fit multiple valve arrangements.

The wrench and support bracket can be included in a tool repair kit to address problems relating to the installation of new tubing, as well as relating to the cracking of valve arms/ports during installation/maintenance.

### BRIEF DESCRIPTION OF THE DRAWINGS

FIG. 1 is a perspective view of an exemplary valve, in accordance with the prior art.

FIG. 2 is a top perspective view of a bracket according to an embodiment of the present invention.

FIG. 3 is a bottom perspective view of the bracket of FIG. 2 as engaged with the valve of FIG. 1.

FIG. 4 is a perspective view of a wrench according to an embodiment of the present invention.

FIG. 5 is a side elevation view of wrenches as shown in FIG. 4, engaged with a bracket/valve combination as shown in FIG. 3, among a set of bracket/valve combinations.

While the disclosure is susceptible to various modifications and alternative forms, specific embodiments thereof are shown by way of example in the drawing and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure as defined by the appended claims.

### DETAILED DESCRIPTION OF THE INVENTION

Embodiments of this invention relate to an installation system for valves. As discussed above, FIG. 1 illustrates a prior art valve 1, and specifically valve part number 009-0272-900 manufactured by Parker Hannifin Corporation, although other valves may be used. Valve 1 includes a generally cylindrical upper portion 2, and a generally cubic lower portion 4 with opposing left and right arms 6 extending from the left and right sides of the lower cubic portion 4. Each of the opposing arms 6 includes a port 8, which connects the valve to a liquid or gas stream. At least a portion of each arm 6 is therefore generally squared-off rather than rounded, so as to allow a wrench to easily grasp the arm 6. The bottom 10 of the lower cubic portion 4 may have at least one threaded mounting hole.

According to prior art procedures, a prior art wrench (not shown) is typically used to grasp an arm 6 of the valve 1 while a liquid or gas line is connected to the port 8 on that arm 6. At times, significant force is applied to the arm 6 during this process, causing arm 6 to bend. By bending an arm 6, hazardous leaks may be caused. Replacing the entire valve 1 is therefore necessitated.

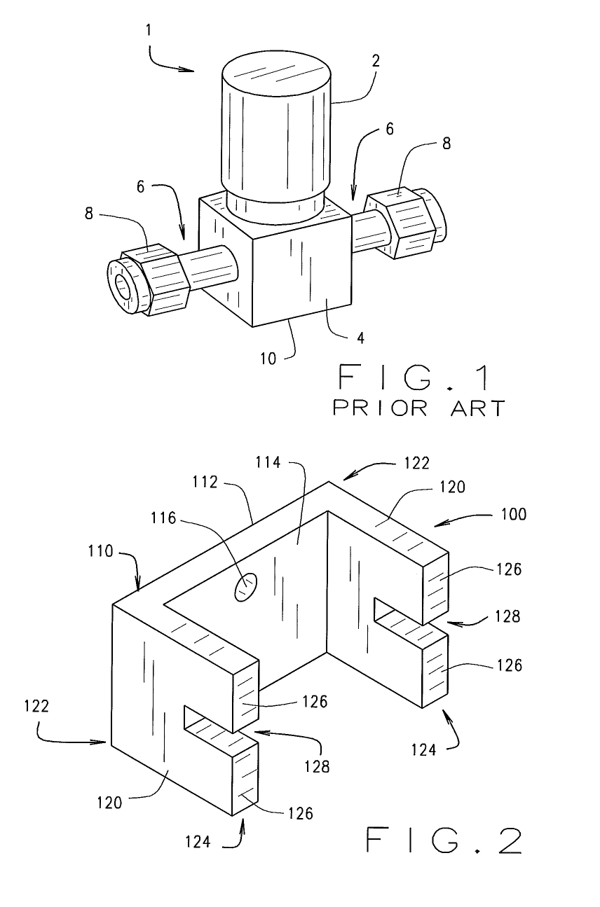

FIG. 2 illustrates a bracket 100 according to an embodiment of the present invention. Bracket 100 includes a generally planar bottom section 110 with a top surface 114 and a bottom surface 112. As shown, planar bottom section 110 is generally rectangular in shape, although other shapes may be used instead depending on the valve 1 to be used. Opposing left and right side sections 120 each extend perpendicularly in the same direction from opposing sides of the bottom section 110, creating an approximately 90 degree angle with the top surface 114 of the planar bottom section 110. A space is thereby created between the left and right side sections 120 which is sized and shaped to receive the cubic lower portion 4 of the valve 1 shown in FIG. 1. Again, differently sized and shaped side sections 120 may be used depending on the valve 1 to be used. Also, a bracket having a third side section may be used with a three-way valve with three arms.

Each side section 120 preferably affixes to the bottom section 110 at a proximal end 122, and extends outwardly to a distal end 124. The distal end 124 of each side section 120 preferably terminates with two prongs 126, which define a recess 128 therebetween. The recess 128 is preferably sized and shaped to receive and provide support to an arm 6 of valve 1 therein.

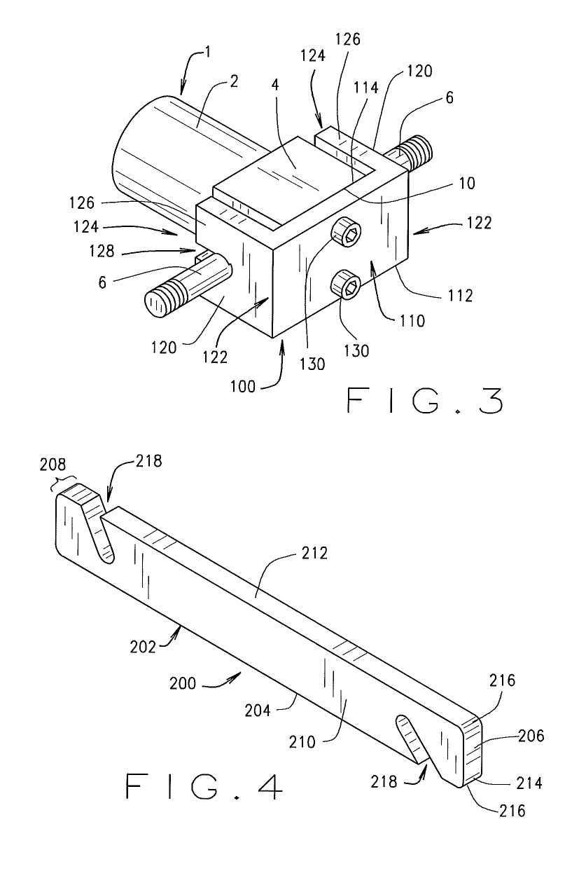

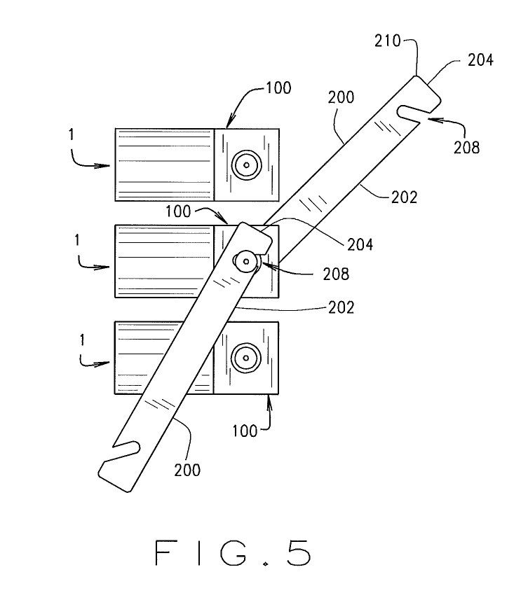

In operation, and as shown in FIG. 3, cubic lower portion 6 of valve 1 slides between the side sections 120 until the bottom 10 of the lower cubic portion 6 of valve 1 and the top surface 114 of the planar bottom section 110 of the bracket 100 abut one another. The bottom section 110 of bracket 100 may include one or more through-holes 116 which align with the threaded mounting holes on the valve 1 upon inserting the valve 1 between the side sections 120 of the bracket 100. A screw 130 or any other known securement device may then be inserted through the through-holes 116 and into the threaded mounting holes in valve 1 to releasably secure the bracket 100 to the valve 1.

As can be seen, the recess 128 between prongs 126 of each side section 120 allow the respective arm 6 of valve 1 to reside between the prongs 126 on a side section 120 when valve 1 is engaged with bracket 100. Therefore, when properly engaged with a valve 1, the opposing arms 6 of the valve 1 extend through the recesses 128 in the side sections 120 of the bracket 100. The prongs 126 thereby act to brace the arms 6 of the valve 1. The extra bracing support provided by to the arms 6 of valve 1 by side sections 120 and prongs 126 help prevent against bending of the arms 6 from too much lateral or twisting force during, for example, installation of the valve 1.

Thus, bracket 100 may be useful when installing new tubing connected to a valve 1. As discussed above, a worker would normally have to (a) hold the valve 1, (b) hold the tubing against the valve port 8, and (3) tighten the compression fitting, all at the same time. By using bracket 100 in connection with valve 1, the worker need only hold the tubing against valve port 8 and tighten the compression fitting. The bracket 100 provides the needed counter-torque necessary to allow tightening of the compression fitting.

In an alternative embodiment, a bracket may lack the through-holes in the bottom section.

In order to releasably secure such an alternative bracket to a valve 1, the alternative bracket may be constructed out of an elastically deformable material which can snap onto the valve 1. For example, such an alternative bracket may have an inwardly extending flange at the distal ends of the side sections. Thus, when the lower cubic portion 6 of the valve 1 is inserted between the side sections, the side sections elastically deform outwardly to allow the lower cubic portion 6 to fit between the inwardly facing flanges. When the lower cubic portion 6 has been fully inserted into the alternative bracket, the side sections can rebound to their original positions, and the flanges would project overtop of the lower cubic section 6 of valve 1, thereby retaining it in place. The bracket may instead attach to the valve 1 by any another known method.

Additionally, in one embodiment as shown in FIG. 4, the invention includes an improved wrench 200 used to secure the arms 6 of valve 1 while the connection of the delivery line to a port 8 is being tightened. The wrench 200 preferably includes a body 202 which is elongated and generally rectangular in shape. Thus, the body 202 generally has a length 204 much longer than its width 206, and a depth 208 which is smaller than the length 204 or width 206. The length 204 and width 206 define the wrench's front and back sides 210. The length 204 and depth 208 define the wrench's top and bottom sides 212. The width 206 and depth 208 define the wrench's front and back sides 214. Any or all of the four corners 216 may be rounded or chamfered. For the purposes of this disclosure, a corner 216 is the intersection of a top or bottom side 212, and a front or back side 214.

Along the top side 212 of wrench 200, proximate either the front or back side 214, the body 202 preferably includes a cutout 218 sized and shaped to receive an arm 6 of a valve 1 therein. The cutout 218 is preferably angled at about 45 degrees into the body 2 and away from the proximate side 214. The cutout 218 preferably extends all the way through the depth 208 of the body 202, but not all the way through its width 206. The bottom side 212 may have a similar cutout 218 on the other of the front or back side 214, as shown in FIG. 4.

In operation, the positioning and orientation of the cutout 218 and the shape of the body 202 allow the wrench 200 to engage with the arm 6 of a valve 1 even when the valve 1 is fitted among other nearby valves 1. Specifically, the size and shape of the wrench 200 allows it to fit between adjacent valves 1. Further, the positioning and orientation of the cutout 218 cause a user to insert the wrench slightly beyond the arm 6 of the appropriate valve 1, and then to pull the wrench backwards and downwardly in order to fit the arm 6 of the valve 1 into the cutout 218. In this position, the arm 6 of the valve 1 is less likely to slip out of the cutout 218, because the weight of the wrench 200 serves to force the arm 6 further into the cutout 218, rather than out of the cutout 218 as would be the case for standard wrenches. Further, the user is less likely to cause the arm 6 of the valve 1 to bend due to the orientation of the cutout 218 in the body 202 of the wrench 200. The inwardly angled orientation of cutout 218 allows a user to apply the proper rotational force, but makes applying too much straight-line force more difficult. Thus, wrench 200 could be held in one hand while another wrench is held in the worker's other hand, and both could be used to secure the port 8 of valve 1 to the tubing.

Thus, a system for installing a valve 1 includes a bracket 100 and a wrench 200. Bracket 100 and wrench 200 allow users to install valves 1 with less chance for damaging the valve 1, whether a new valve 1 or new tubing is being installed.

Thus, there has been shown and described an embodiment of a valve installation system. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An installation system for a valve comprising:
a bracket for releasable securement to the valve, the valve having an upper portion and a generally cubic lower portion, with opposing arms extending from a left and right side of the lower cubic portion, the bracket including:
a bottom section with left and right sides;
left and right side sections, each extending perpendicularly from its respective side of the bottom section so as to create an approximately 90 degree angle with the top surface of the bottom section, wherein each side section extends from a proximal end affixed to the bottom section, to a distal end;
two prongs at the distal end of each side section, the two sets of two prongs each defining a recess therebetween, wherein each recess is sized, shaped and positioned to receive and brace an arm of the valve when the valve is engaged with the bracket; and
a wrench including:
a body portion having with a length with opposing ends, a width shorter than the length, and a depth;
a cutout along the length of the body proximate at least none of the ends of the body, said cutout being angled into the body and away from the proximate end of the body, wherein said cutout is sized and shaped to receive an arm of the valve therein and secure the arm against independent movement.

2. The installation system of claim 1 wherein the bottom section of the bracket includes at least one through-hole which aligns with at least one threaded mounting hole in the cubic lower portion of the valve, said at least one through-hole and at least one threaded mounting hole for receiving a screw therein to releasably engage the bracket and valve.

3. The installation system of claim 1 wherein the left and right side sections selectively engage the bracket with the valve by elastically deforming outwardly to receive the valve therebetween, and subsequently rebounding to a position which retains the valve in place.

4. The installation system of claim 1 wherein the cutout in the body of the wrench is angled at about 45 degrees.

5. The installation system of claim 1 wherein the cutout in the body of the wrench extends partially through the width of the body, and extends all the way through the depth of the body.

6. The installation system of claim 1 wherein at least a corner of the wrench is rounded off.

7. The installation system of claim 1 wherein at least a corner of the wrench is chamfered.

8. An installation system for a valve having an upper portion and a generally cubic lower portion, with opposing arms extending from a left and right side of the lower cubic portion, the system comprising:
a bracket for releasable securement to the valve, the bracket including:
left and right side sections connected by a bottom section therebetween, said left and right side sections extending perpendicularly from respective sides of the bottom section;
two prongs at an end of each side section distal to from bottom section;
a recess between the two prongs on each side section, said recess for receiving an arm of the valve when the valve is engaged with the bracket; and
a wrench having a length, width, and depth, the length and width defining left and right sides, the length and depth defining top and bottom sides, and the width and depth defining front and back sides,
wherein at least one of the top and bottom sides have a cutout therein proximate the front or back side, said cutout being angled at about 45 degrees into the wrench and away from the proximate front or back side, wherein said cutout is sized and shaped to receive an arm of the valve therein and secure the arm against independent movement.

9. A bracket for releasable securement to a valve having an upper portion and a generally cubic lower portion, with opposing arms extending from a left and right side of the lower cubic portion, the bracket comprising:
a bottom section with left and right sides;
left and right side sections, each extending perpendicularly from its respective side of the bottom section so as to create an approximately 90 degree angle with the top surface of the bottom section, wherein each side section extends from a proximal end affixed to the bottom section, to a distal end;
two prongs at the distal end of each side section, the two sets of two prongs each defining a recess therebetween, wherein each recess is sized, shaped and positioned to receive and brace an arm of the valve when the valve is engaged with the bracket.

10. A wrench for securing a valve to tubing, the valve having an upper portion and a generally cubic lower portion and with opposing arms extending from a left and right side of the lower cubic portion, the bracket comprising:
a body portion having with a length with opposing ends, a width shorter than the length, and a depth;
a cutout along the length of the body proximate at least none of the ends of the body, said cutout being angled into the body and away from the proximate end of the body,
wherein said cutout is sized and shaped to receive an arm of the valve therein and secure the arm against independent movement.
